(19) United States
(12) Patent Application Publication
(10) Pub. No.: US 2006/0102021 A1
(43) Pub. Date: May 18, 2006

(54) Printing device for printing conical objects

(76) Inventors: Harrie Van Dijk, Mijdrecht (NL); Bram Bergsma, Haarlem (NL); Henk Van der Ven, Amstelveen (NL); Hielke Mollema, Uitgeest (NL)

Correspondence Address: LADAS & PARRY, 26 WEST 61ST STREET, NEW YORK, NY, 10023, US

(21) Appl. No.: 10/539,096

(22) PCT Filed: Dec. 16, 2003
(86) PCT No.: PCT/NL03/00894

§ 371 Date: Jun. 15, 2005

(30) Foreign Application Priority Data
Jan. 10, 2003 (NL) 1022345

(51) Int. Cl. B41F 17/00

(52) U.S. Cl. 101/35

(57) ABSTRACT

The invention relates to a device for printing conical objects (5) comprising a printing member having one or a number of successive printing plates (25) or printing cloths (21), a driving mechanism for the printing member, one or more printing units (16) for applying printing ink and one or more counterpressure members on which the conical objects (5) are held and supported during printing, the surface of the printing member onto which printing plates or printing cloths are applied having at least the inner or outer surface of a circular cone and such ratios being provided that the circumferential velocities of printing member and the conical object to be printed are identical or almost identical to one another on every point of the line of contact between them.

The present invention relates to a device for printing objects having a conical surface to be printed, said device providing a printing member having one or a number of successive printing plates or printing cloths, a drive for the printing member, one or more printing units for applying printing inks onto printing plates or printing cloths and one or more counterpressure members on which said surface to be printed is held and supported while being printed.

A similar device is known per se. With this known device, the printing member comprises a cylindrical drum having a circular cross-section, with one or more printing cloths for offset printing being applied on the drum wall. The drum of said printing member is rolled against the objects to be printed, which to that end have been mounted on a rotatable support which functions as counterpressure member. The objects to be printed are generally conical supports for use in the food industry, such as yoghurt cups, for example. Other than for product designation, guarantee conditions and further relevant information, the print on these cups serves to an important degree for inciting the consumer to buy the product. In addition to colour, colour combinations, logos and the like, an important requirement is that the print per se is well-defined and clear. With the known printing drum, this last aspect is a problem because the peripheral velocity of the printing drum and the conical object to be printed can not be uniform on every point along the line of contact when unrolling. This causes smearing of the printing ink which can be thus annoying especially at lower and upper edge of the print that it may seriously spoil the presentation of the product per se. Obviously this will have a direct negative effect on sale of the product.

Thus, the object of the invention is to provide a device for printing conical objects in which such a smearing does not occur or can be largely prevented. Accordingly, the invention provides for that the surface of the printing member onto which the printing plates or printing cloths are applied, is at least partly formed in such a way, that on rolling of the printing plates or printing cloths across the conical surface of the object to be printed the circumferential velocities of printing member and conical surface to be printed are uniform or almost uniform at every point along the full line of contact or at the complete contact surface. In addition to the fact that this can prevent smearing, at the same time this gives the further advantage that the printing cloths employed in offset printing will not be damaged by the otherwise occurring slip, and will therefore last longer.

According to a first embodiment to that end it is provided for, that the surface of the printing member onto which printing plates or printing cloths are applied has at least partly the inner or outer surface of a circular cone. By providing for that the printing member surface, onto which printing cloths are applied in offset printing or printing plates are applied in flexo printing, is a cone surface, its circumferential velocity can be the same as that of the outer surface of a conical cup or object to be printed.

Basically, it is possible to employ the inside of a cone for applying printing cloths or printing plates, by which a particularly compact structure can be achieved. Generally however it is preferred to employ the outside which offers easier use and better accessibility of the device. Preferably, the printing member surface onto which printing cloths or printing plates are applied is in the shape of a truncated circular cone, in which the height of the truncated circular cone need not be much larger than necessary for being able to print the largest occuring conical object to be printed.

Instead of a cone surface one could possibly employ a plane printing surface as well, in which the object to be printed will be contacted with the printing surface at a predetermined distance from the pivot point. In that specific embodiment this has the disadvantage that the printing member gets the largest diameter and that it can not be easily incorporated in existing printing devices.

The objects to be printed should be applied on a reservoir which acts as a counterpressure member. Here, the counterpressure member or each of the counterpressure members are in the shape of a truncated circular cone, in which a counterpressure member with an object to be printed will be positioned in a predetermined position in relation to the printing member and that the axes of printing member and counterpressure member intersect one another in a predetermined point.

Since the cone angle of conical supports or cups has not been standardized, in practice there is a large number of different angles. For each conical object, an exactly matching counterpressure member is provided, since a non-supported surface can hardly be printed, Basically, it will then be possible to put the various counterpressure members in exactly the position and at the correct distance in which they will end up in the proper position in relation to the printing cloth applied on the printing member. However, this is not preferred since such adjusting possibilities, in which angle and position can be adjusted, generally produce deviations which are too large, which in turn will directly affect the quality of the print.

Therefore, one preferably starts from an average cone angle or from the most frequently employed cone angle, in which one can always use a predetermined position and orientation. As a result, part of the conical objects to be printed will have deviations in the print, however these are relatively small and not annoying. In comparison to the deviations as they occur at present, the deviations occurring in the print in part of the objects in the device according to the invention are minimal.

The counterpressure members are part of an object support known per se for conical objects. This object support substantially comprises counterpressure members mounted on the outer ends of arms projecting radially in relation to a common pivot point, in which the conical objects can be held on said counterpressure members by an underpressure, for example. The number of counterpressure members equals the number of printing plates or printing cloths on the printing member or are in a predetermined relation to them and thus the numbers of revolutions per unit of time of object support and printing member are also equal or are in a certain relation to one another.

Therefore, according to a further elaboration it is provided for, that the circumferential length of the circular cone-shaped printing member is chosen depending on the number of printing plates or printing cloths to be mounted on the printing member and on the driving speeds of printing member and object support and that the cone angle of the printing member is chosen depending on the circumferential length of the printing member and the cone angle of the conical object to be printed. Here again, one starts from an average cone angle or the most frequently occurring cone angle of conical objects to be printed.

With the printing member according to the invention it is further provided for that the printing unit for offset print has a conical printing plate cylinder having such a cone angle and orientation of the cone axis that the conical printing plate cylinder exactly connects to the cone surface of the printing member. Here the connection of printing plate cylinder and printing member can be very accurate because here the dimensions and angle are always the same.

In order to be able to use a conical printing plate cylinder, according to the invention it is further provided for that the printing unit further has at least one conical form roller connecting to the conical printing plate cylinder, and that the conical form roller is preceded by a distribution roller having such a cone angle that the oscillating cylinder mounted between distribution roller and form roller can have a circular cross-section. The further rollers preceding the conical distribution roller, including ink roller, vibrating roller and further distribution roller can likewise be cylindrical having a circular cross-section.

In the following, the invention will be further explained by way of the example given in the drawing, in which:

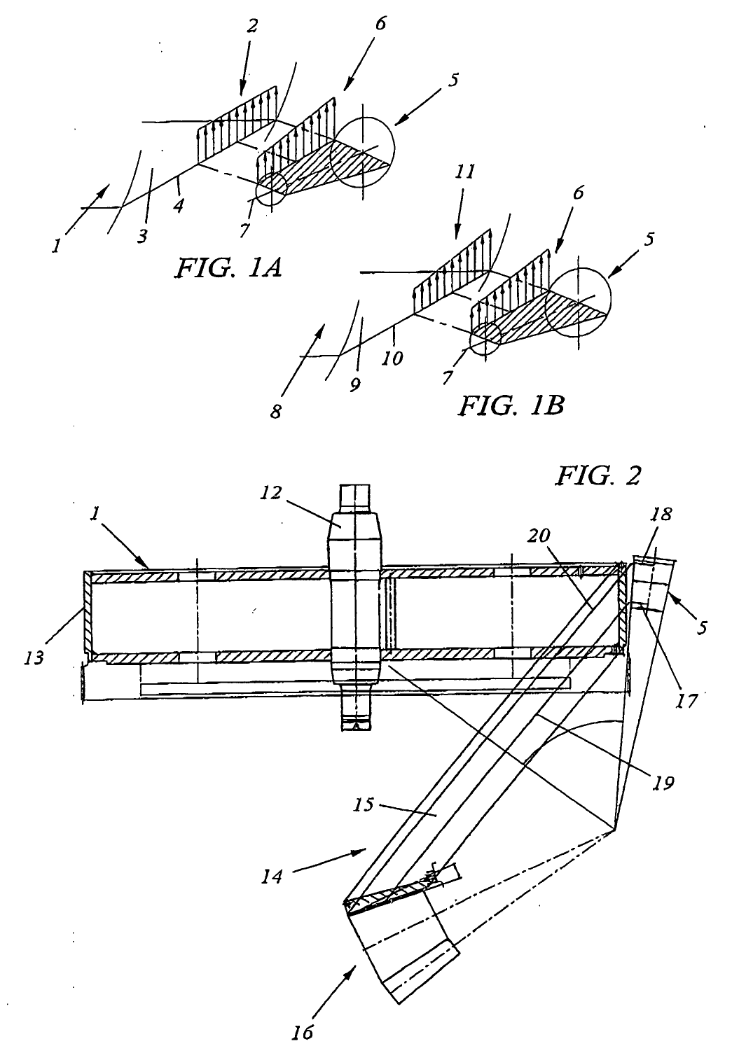

FIGS. 1A,B indicates schematically the change of velocity along the printing member and the object to be printed;

FIG. 2 illustrates schematically a cilindrical and conical printing member with an object to be printed;

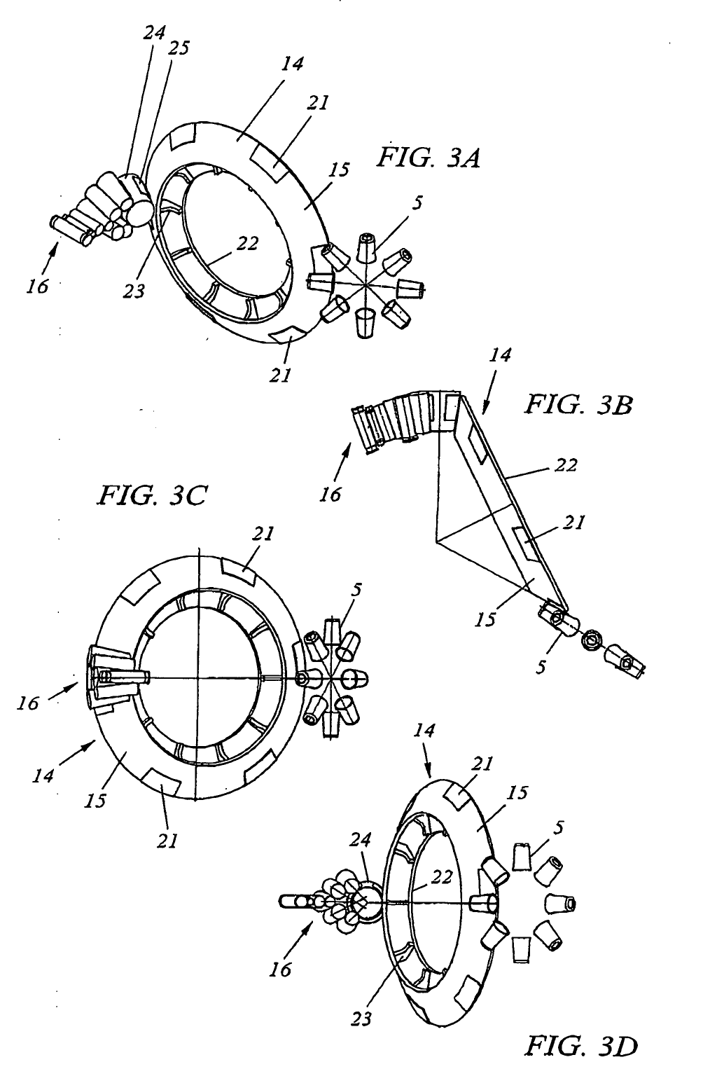

FIGS. 3A-D illustrate views of a conical printing member with an object support and a printing unit;

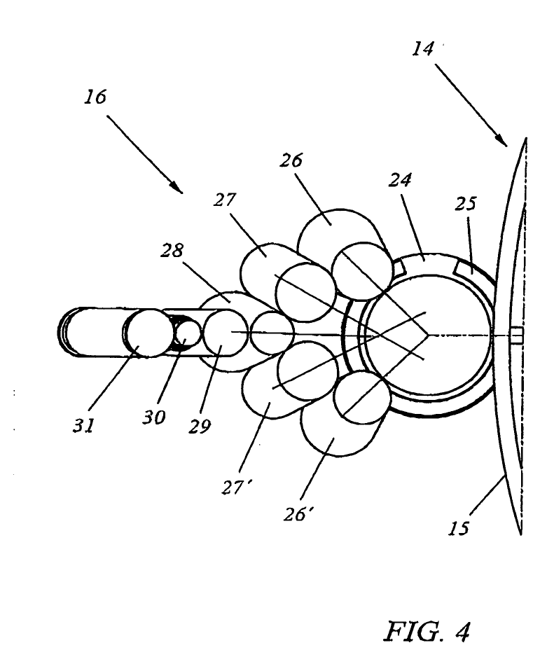

FIG. 4 illustrates a printing unit in more detail; and

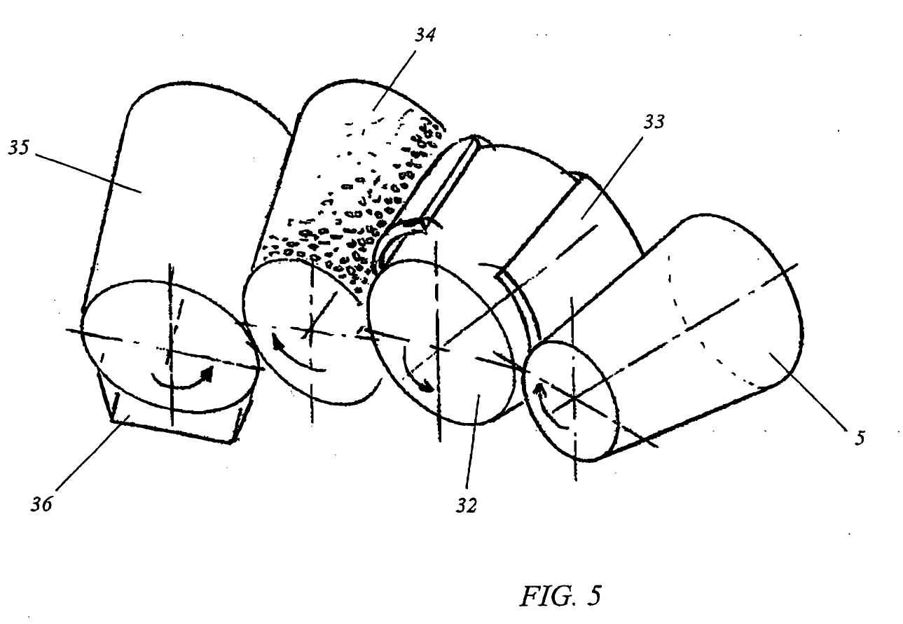

FIG. 5 illustrates schematically a conical printing member for flexo-printing.

FIG. 1A illustrates schematically a cylindrical printing member 1, in which vectors 2 indicate the circumferential velocity at the printing surface 3 along a line 4 parallel to the axis of rotation. It is clear that this velocity will be the same anywhere along said line 4, which will also be the line of contact with the object to be printed. The conical object 5 to be printed is of different diameter at opposite edges of the surface to be printed, so that on rotation of the object there will also be a difference in circumferential velocity. The vectors 6 indicate the change of the circumferential velocity along a line parallel to the cone axis 7. A similar printing member 1 for printing conical objects represents the known state of the art.

When printing the conical surface of the conical object 5 with cylindrical printing member 1 the conical object 5 unwinds along printing member 1 and slip will occur at locations along the line of contact where the circumferential velocity of the conical object 5 can not be equal to that of said printing member 1. This causes smearing of the printing ink and also damage of the printing cloth mounted on said printing member 1.

The invention is based on the idea indicated in FIG. 1B. This illustrates schematically a printing member 8 having a surface 9 onto which printing plate or printing cloth is mounted, having a difference in circumferential velocity along line 10, indicated by vectors 11, corresponding to the difference in velocity with the conical object 5. In case of a completely equal velocity there will be no slip and therefore damage of the printing cloths is prevented too.

FIG. 2 illustrates an existing cylindrical printing member 1 having a circular cross-section. The printing member 1 is mounted on a shaft 12 which is driven with the help of means not further indicated in the drawing. The surface 13 is provided with printing cloths not further indicated. The jacket to be printed of a conical object 5 is brought against surface 13 of printing cloths mounted on it in parallel, whereupon conical object 5 will unwind against printing member 1. This causes the disadvantages mentioned above.

Further, the figure illustrates schematically a printing member 14 according to the invention, which is truncated cone-shaped and has a surface 15, onto which the printing cloths are mounted, which is part of a cone surface. Further, a printing unit 16 is provided, which is intended for bringing printing ink onto the printing cloths on the cone surface 15.

Lines 17, 18 on the conical object 5 indicate the edges of the surface to be printed. On the conical printing member 14, the respective lines 19, 20 indicate the corresponding limit on the cone surface 15. The ratios between the lines 17,18 and 19,20 and thus the ratios between the respective diameters are chosen in such a way, that the circumferential velocities along the cone surface 15 and the conical object 5 are identical.

FIGS. 3A-D illustrate a number of schematic views of a conical printing member 14, with a number of printing cloths 21 being mounted on the conical surface 15. The conical printing member 14 is of truncated cone-shape and composed of a plane baseplate 22, part of a cone surface 15 and a number of reinforcing ribs 23 mounted between base plate 22 and cone surface 15. The base-plate 22 is provided with bearing and fastening means not further indicated in the drawing.

The conical objects 5 are held on counterpressure members not further indicated which are mounted on radial arms of an object support known per se. This object support is provided with a driving mechanism synchronized with the drive mechanism of the printing member 14 in such a way that a next object 5 to be printed will be contacted with the printing member 14, printing cloth 21 in exactly the right moment.

The printing unit 16 is adapted to the conical printing member 14 to wit in that sense that the printing plate roller 24 with printing plate 25 is embodied such that likewise a circumferential velocity is achieved that corresponds to the one of conical printing member 14, See further FIG. 4. The number of necessary printing units 16 for offset printing per printing member 14 depends on the number of colours to be applied.

FIG. 4 illustrates the printing unit 16 in more detail. It is important that the printing plate cylinder 24 with printing plate or cliche 25 will contact printing member 1 with printing cloths 21 at an overall identical circumferential velocity. To that end, the ratios between the respective diameters are exactly adjusted to one another. In order to be able to apply the printing ink on the printing plate 25 in the proper amount and distribution, form rollers 26,26′, oscillating rollers 27,27′ and distribution rollers 28, 29 are provided as usual. For that purpose form rollers 26,26′ have been designed conically with exactly the right cone shape. The oscillating cylinders 27,27′, rotating along with the rollers 26,26′, serve for effecting a proper distribution of the printing ink and also for performing a movement in axial direction. All this is achieved by providing a conical distribution roller 28 being positioned in relation to the form rollers 26,26′ in such a way that the spaces between the distribution roller 28 and the form rollers 26,26, have parallel limits.

The further rollers are distribution roller 29, vibrating roller 30 and ink roller 31, respectively. These are all cylindrical rollers of circular cross-section. Slip occurs between the cylindrical distribution roller 29 and the conical distribution roller 28, which however is of minor importance in this portion of the printing unit 16.

FIG. 5 illustrates a simple embodiment of a printing member according to the invention intended for use in flexo-printing. The printing member 32, provided with a printing plate 33, is also of conical shape, the ratios in relation to the object to be printed being again chosen in such a way that there will be no slip during rolling against the object 5. From printing ink reservoir 36, the printing ink is transferred to conical applying roller 34 with the help of cylindrical roller 35, and from there to printing plate 33. Instead of a printing member having one single printing plate 33, printing member 32 can also be made bigger and be provided with more printing plates.

1. Device for printing objects having a conically shaped surface to be printed, said device providing a printing member having one or a number of successive printing plates or printing cloths, a drive mechanism for the printing member, one or more printing units for applying printing inks onto printing plates or printing cloths and one or more counterpressure members on which said surface to be printed is held and supported while being printed, characterized in that the surface of the printing member onto which the printing plates or printing cloths are applied, is at least partly formed in such a way, that on rolling of the printing plates or printing cloths across the conical surface of the object to be printed the circumferential velocities of printing member and conical surface to be printed are uniform or almost uniform at every point along the full line of contact or at the complete contact surface.

2. Device according to claim 1, characterized in that the surface of the printing member onto which printing plates or printing cloths are applied has at least partly the inner or outer surface of a circular cone.

3. Device according to claim 2, characterized in that the surface of the printing member onto which printing plates or printing cloths are applied is in the shape of a truncated circular cone.

4. Device according to claim 3, characterized in that the the counterpressure member or each of the counterpressure members are in the shape of a truncated circular cone, in which a counterpressure member with an object to be printed will be positioned in a predetermined position in relation to the printing member and that the axes of printing member and counterpressure member intersect one another in a predetermined point.

5. Device according to claim 1, further comprising a driven object support for conical objects, said object support substantially consisting of a number of counterpressure members, intended for being able to receive a conical object, which are mounted on the outer ends of arms projecting radially in relation to a common pivot point, characterized in that the circumferential length of the circular cone-shaped printing member is chosen depending on the number of printing plates or printing cloths to be mounted on the printing member and on the driving speeds of printing member and object support and that the cone angle of the printing member is chosen depending on the circumferential length of the printing member and the cone angle of the conical object to be printed.

6. Device according to claim 5, characterized in that for the cone angle of the conical object to be printed one starts from an average cone angle or the most frequently occurring cone angle of the conical objects to be printed.

7. Device according to claim 1, characterized in that the printing unit for offset print has a conical printing plate cylinder having such a cone angle and orientation of the cone axis that the conical printing plate cylinder exactly connects to the cone surface of the printing member.

8. Device according to claim 7, characterized in that said printing unit further has at least one conical form roller connecting to the conical printing plate roller.

9. Device according to claim 8, characterized in that the conical form roller is preceded by a distribution roller having such a cone angle that the oscillating cylinder mounted between distribution roller and form roller can be of circular cross-section.

10. Device according to claim 9, characterized in that the further rollers preceding the conical distribution roller, including inking roller, vibrating roller and further distribution roller, are cylindrical and of circular cross-section.

11. Printing unit for use together with the device according to claim 1, characterized in that the printing unit for offset print has a conical printing plate cylinder having such a cone angle and orientation of the cone axis that the conical printing plate cylinder exactly connects to the cone surface of the printing member.

12. Printing unit according to claim 11, characterized in that at least one conical form roller connecting to the conical printing plate roller has been provided.

13. Printing unit according to claim 12, characterized in that the conical form roller is preceded by a distribution roller having such a cone angle that the oscillating cylinder mounted between distribution roller and form roller can be of circular cross-section.

14. Printing unit according to claim 13, characterized in that the further rollers preceding said conical distribution roller, including ink roller, vibrating roller and further distribution roller are cylindrical and of circular cross-section.
